(19) United States
(12) Patent Application Publication
(10) Pub. No.: US 2006/0288585 A1
(43) Pub. Date: Dec. 28, 2006

(54) Knife

(76) Inventor: Chih-Chen Kao, Taoyuan City (TW)

Correspondence Address: BACON & THOMAS, PLLC, 625 SLATERS LANE, FOURTH FLOOR, ALEXANDRIA, VA, 22314, US

(21) Appl. No.: 11/167,088

(22) Filed: Jun. 28, 2005

(51) Int. Cl. B26B 1/02

(52) U.S. Cl. 30/159

(57) ABSTRACT

The present invention is to provide a foldable knife operable with one single hand, which comprises a knife holder including a retaining space formed between a first plate and a second plate, a blade body having one end pivotally connected to one end of the knife holder and capable of being retained in the retaining space or rotated out of the retaining space, at least an actuating rod formed on one surface of the blade body; and an actuating portion formed on the first plate to cooperate with the actuating rod. When the knife body is retained in the retaining space, the actuating rod is aligned to the adjacent actuating portion adapted to push the actuating rod moving towards outside of the knife holder, thereby pushing the blade body out of the retaining space.

### FIELD OF THE INVENTION

The present invention relates to a foldable knife, more particularly to a foldable knife having an actuating portion adapted to push a blade body out of a retaining space of the foldable knife by one single hand of a user.

### BACKGROUND OF THE INVENTION

The currently commercially available foldable knife is illustrated in FIG. 1. The foldable knife 10 includes a knife holder 12 and a blade body 11, wherein one end of the blade body 11 is pivotally connected with one end of the knife holder 12. The blade body 11 can thus rotate about the knife holder 12, thereby retaining the blade body 11 into a retaining groove 13 formed on one side of the knife holder 12. When the user wants to open the foldable knife 10, he/she must use one hand to hold the knife holder 12 and the other hand to pull the blade body 11 out of the retaining groove 13, so as to pull out the knife blade 12.

However, the structural design of the conventional foldable knife 10 describe above requires the use of both hands to pull the blade body 11 out of the knife holder 12. Under some special circumstances or for some emergency cases, the user can not pull out the foldable knife 10 with only one free hand. For example, if one hand of a diver were trapped by fishnet, he/she would not have both hands free to open the foldable knife 10 to cut off the fishnet. Therefore, the life of the diver will be threatened if the oxygen contained in the scuba can not sustain until he/she rescues himself/herself.

Therefore, referring again to FIG. 1, some manufacturers of foldable knifes add a protrusively formed actuating rod 14 on both sides of the blade body 11. When the blade body 11 is retained in the retaining groove 13, the two actuating rods 14 provides the user the means to open the knife. Therefore, it is easy to rotate the blade body 11 out of the retaining groove 13 of the knife holder 12 by pushing the actuating rod 14 with only one hand.

However, since modern people requires a more personal and artistic structural design for knifes, the two actuating rods 14 are often very small in size, so as to reduce their influence on the structural design. However, the smaller the actuating rod is designed, the harder for user to open the knife. Especially for those users of unskillful fingers, the force exerted on the small actuating rod often hurts the fingers of the users.

Moreover, the two actuating rods 14 of the foldable knife 10 are often not exceeding the outer edge of the knife holder 12 for the convenience of carrying and for the overall design style. Therefore, when the user of the foldable knife 10 wants to push the actuating rod 14, the force exerted on the actuating rod 14 forms an angle with the direction of the blade body 11 rotating away from the retaining groove 13. The effective force that the user exerted to the actuating rod is thus small due to the presence of such an angle. Even worse, if the direction of the force that the user exerted on the actuating rod 14 is wrong, it is possible that the user can not rotate the blade body 11 out from the retaining groove 13.

For the above reasons, it is an important issue to design a foldable knife that is operable by one single hand, so as to enhance the functionality and the usefulness of the foldable knife, yet keeping the foldable knife of an artistic and esthetic style.

### SUMMARY OF THE INVENTION

In accordance with the background description set forth above, the inventors of the present invention have devoted themselves to the study and experimentation of foldable knifes with due diligence. Finally, a new foldable knife, which is the subject matter of the present invention, is developed.

It is an object of the present invention to provide a foldable knife operable with one single hand. The foldable knife comprises a blade body and a knife holder. The knife holder includes a first plate and a second plate stacked on the first plate. A retaining space is formed between the first plate and the second plate, so as to retain the blade body therein. One end of the blade body comprises a sharp portion, while the other end of the blade body is pivotally connected to one end of the knife holder. In this manner, the blade body can be retained in the retaining space or can be rotated out of the retaining space. At least one surface of the blade body includes an actuating rod formed thereon. An actuating portion is formed on the first plate to cooperate with the actuating rod. When the knife body is retained in the retaining space, the actuating rod is aligned to the adjacent actuating portion. At this time, one can operate the actuating portion to push the actuating rod moving towards outside of the knife holder, thereby pushing the blade body out of the retaining space.

It is another object of the present invention to form an elastic structure in the knife holder. When the actuating portion pushes the actuating rod and moves towards outside of the knife holder, the elastic structure can eject the blade body again out from the knife holder when the blade body is pushed out of the knife holder.

It is yet another object of the present invention to provide a foldable knife that can reduce the force that the user needs to exert for rotating the blade body out of the knife holder. It is much easier to rotate the blade body out of the knife holder by operating the actuating portion to push the actuating rod than operating on the actuating rod directly.

The above and other objects, features and advantages of the present invention will become apparent from the following detailed description taken with the accompanying drawings.

### BRIEF DESCRIPTION OF THE DRAWINGS

FIG. 1 is a perspective view of a conventional foldable knife.

FIG. 2 is a perspective view of a foldable knife of the present invention.

FIG. 3 is an explosive view of the foldable knife of the present invention.

FIG. 4 is a side elevation of the foldable knife, in accordance with one aspect of the present invention.

FIG. 5 a side elevation of the foldable knife, in accordance with another aspect of the present invention.

FIG. 6 is a sectional view of the foldable knife of the present invention before it is being folded.

FIG. 7 a sectional view of the foldable knife of the present invention after it is being folded.

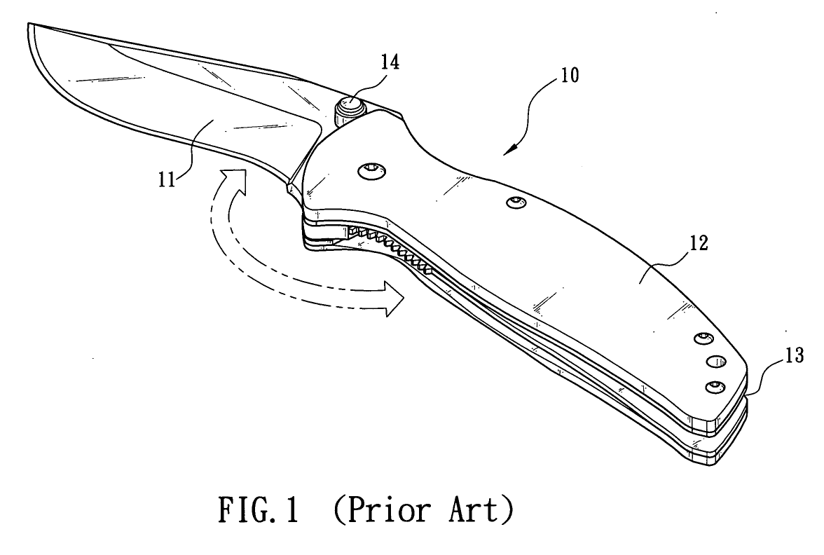

### DETAILED DESCRIPTION OF THE PREFERRED EMBODIMENTS

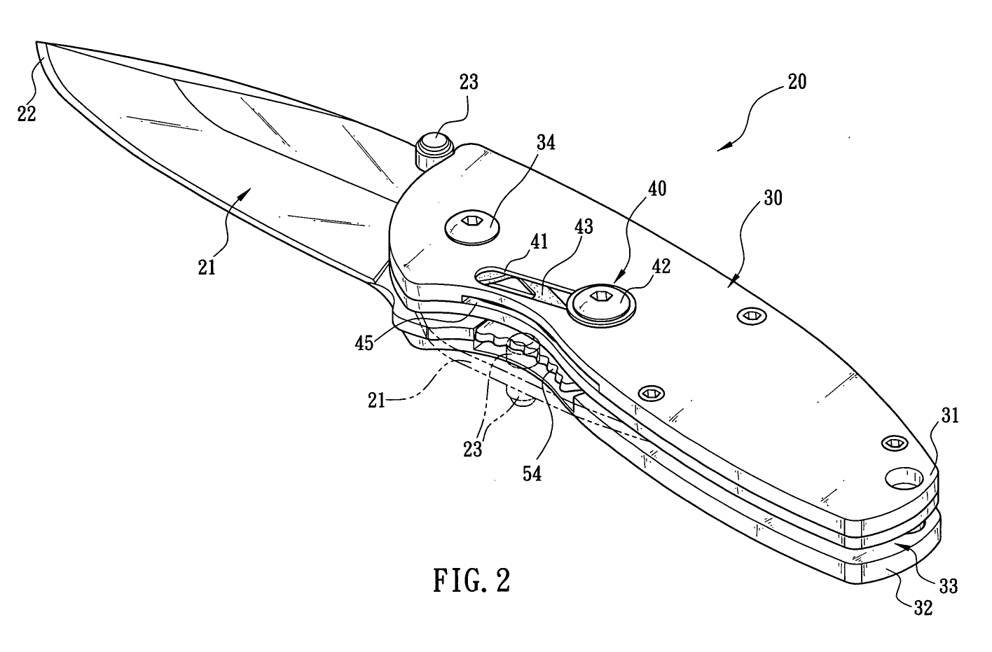

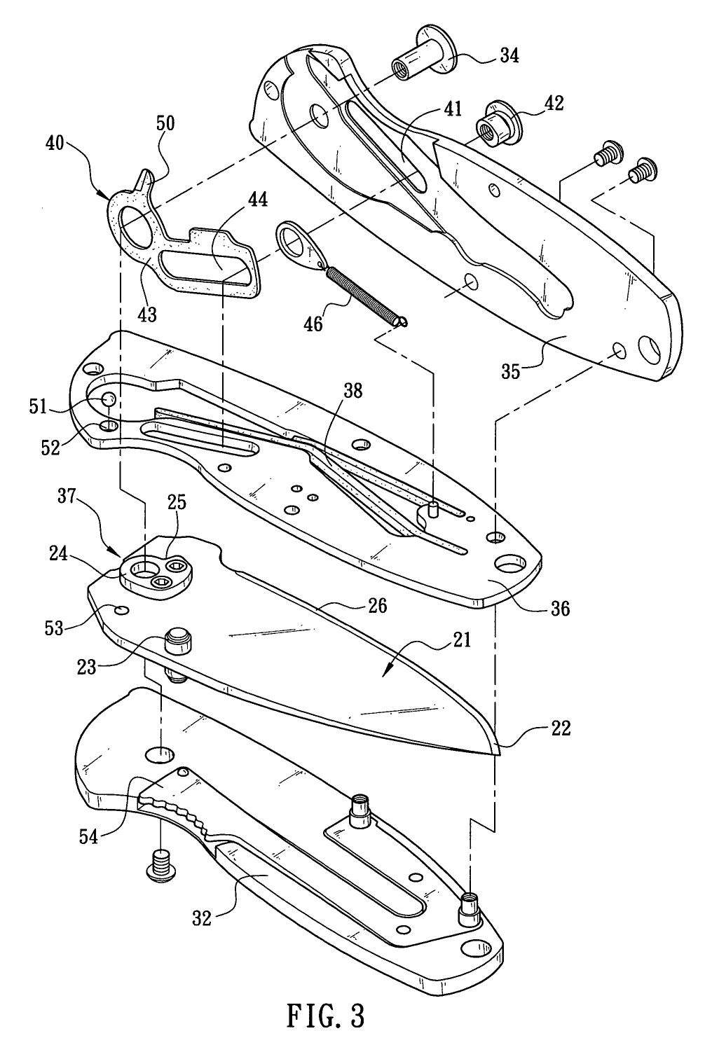

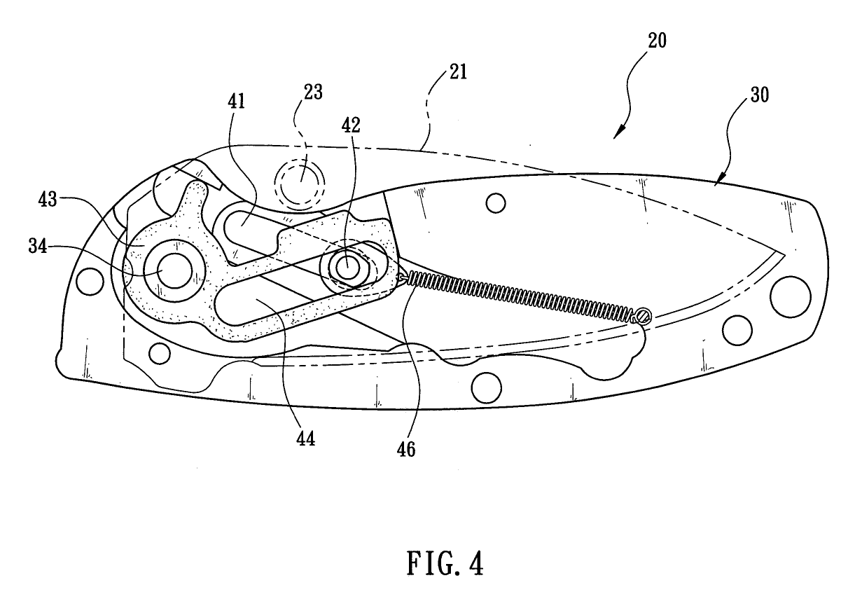

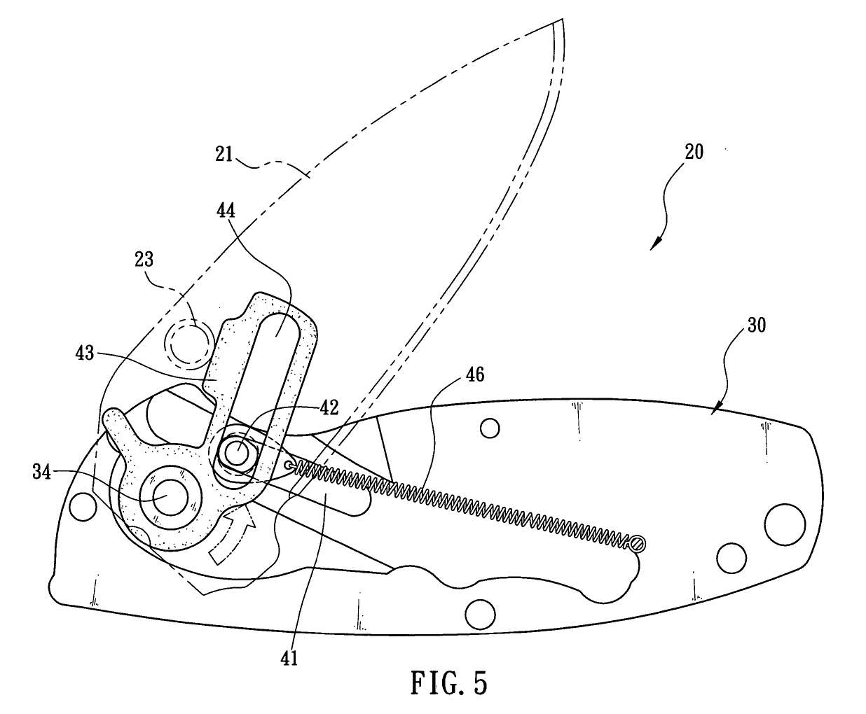

Referring to FIG. 2, a foldable knife of the present invention includes a blade body 21 and a knife holder 30, wherein the knife holder 30 is composed of a first plate 31 and a second plate 32 stacked with the first plate 31. There is formed a retaining space 33 between the first plate 31 and the second plate 32, so as to retain the blade body 21. One end of the blade body 21 includes a sharp portion 22, while the other end is pivotally connected to one end of the knife holder 30. The blade body 21 can then be retained in the retaining space 33, or rotated out from the retaining space. Moreover, at least one surface of the blade body 21 includes an actuating rod 23, while an actuating portion 40 is formed on the first plate 31 incorporating with the actuating rod 23. When the blade body 21 is retained in the retaining space, the actuating rod 23 is situated at the position of the actuating portion 40, as shown in FIG. 3 and FIG. 4. Referring now to FIG. 5, one can push the actuating rod 23 directly from operating the actuating portion 40, so as to push the blade body 21 out from the retaining space 33. In this manner, the blade body 21 is rotated out of the knife holder 30.

Referring again to FIG. 2, the side surfaces of one end of the blade body 21 is pivotally connected to the inner surfaces of one end of the knife holder 30 (i.e. the opposite surfaces of the first plate 31 and the second plate 32) via at least a pivot 34, such that the blade body 21 can rotate about the center of the pivot 34.

Referring to FIG. 2 and FIG. 3, the first plate 31 includes an upper cover 35 and a lower covered 36 stacked with the upper cover 35. The actuating portion 40 is disposed between the upper cover 35 and the lower cover 36. In addition, a guiding hole 45 is formed on one side of the first plate 31 facing the blade body 21 adjacent the actuating portion 40. The guiding hole 45 provides one part of the actuating portion 40 to protrude therefrom. Furthermore, a sliding groove 41 is formed on the upper cover 35 corresponding to the actuating portion 40. One end of a sliding piece 42 of the actuating portion 40 protrudes the first plate 31, thereby providing users of the foldable knife to push thereon. The other end of the sliding piece 42 is restricted between the upper cover 35 and the lower cover 36, such that the sliding piece 42 is moving smoothly when pushed.

In addition, referring again to FIG. 2 and FIG. 3, the actuating portion 40 further includes a foil 43. The one end of the foil 43 and the other end of the foil 43 form a bending angle. The best bending angle is determined according to the position of the sliding groove 41 and the sliding track 44. In this particular embodiment, the bending angle is between 30 degrees and 180 degrees. One end of the foil 43 is pivotally connected to one end of the knife holder 30. In this manner, the other end of the foil 43 can be rotated about the center of the pivotal connections between the foil 43 and the knife holder 30 and protrudes the guiding hole 45, thereby pushing the actuating rod 23. The blade body 21 is then pushed out from the retaining space 33. Further, a sliding track 44 is formed on the other end of the foil 43 so as to dispose the sliding piece 42 therein. Moreover, the sliding track 44 crosses the sliding groove 41.

Referring to FIG. 4, where an aspect of the knife holder 30 is illustrated. The foil 43 is retained in the knife holder 30. The sliding piece 42 is situated in the sliding groove 41 away from the other end of the foil 43. The sliding piece 42 is also situated in the sliding track 44 away from the other end of the foil 43. Referring to FIG. 5, where another aspect of the knife holder 30 is illustrated. The sliding piece 42 moves along the sliding groove 41 towards the other end of the foil 43. At the same time, the sliding piece 42 is situated in the sliding track 44 pushing the foil 43 to move. The sliding track 44 can thus move along the sliding piece 42, so as to protrude the foil 43 out of the knife holder 30 and to push the actuating rod 23.

Referring to FIG. 2, FIG. 3, FIG. 4, and FIG. 5, the foil 43 in the present invention can be pivotally connected with the pivot 34. In this manner, the foil 43 can rotate about the center of the pivot 34. However, it is appreciated that the foil 43 can be pivotally connected to any position of the handle 30. As long as the foil 43 can rotate within the knife holder so as to protrude part of the foil 43 out of the guiding hole 45 thereby pushing the actuating rod 23, it is considered within the scope of the present invention.

Referring again to FIG. 3, the actuating portion 40 further includes a recovery spring 46. The recovery spring 46 is disposed between the upper cover 35 and the lower cover 36. One end of the recovery spring 46 is connected with the sliding piece 42, while the other end thereof is connected with the other end of the first plate 31 away from the pivot 34. The recovery spring 46 is preferably disposed on the upper cover 35 (or the lower cover 36) directly facing the sliding groove 41. In this manner, referring to FIG. 4, when the sliding piece 42 is situated in the sliding groove 41 away from the other end of the foil 43, the pitch of the recovery spring 46 is denser. On the other hand, referring to FIG. 5, when the sliding piece 42 is moving in the sliding groove 41 towards the other end of the foil 43, the pitch of the recovery spring 46 becomes looser, thereby generating an elastic recovery force. This elastic recovery force will be used to pull the sliding piece 42 back to the position in the sliding groove 41 away from the other end of the foil 43. Thus, after the user of the foldable knife 20 pushes the sliding piece 42 to rotate out the blade body 21 from the knife holder 30, the foil 43 and the sliding piece 42 can be recovered to their original position by taking advantage of the elastic recovery force.

Referring again to FIG. 3, the knife holder 30 (as shown in FIG. 2) includes an elastic structure 37. When the actuating portion 40 pushes the actuating rod 23 to move towards outside of the knife holder 30 and the blade body 21 is pushed outside of the knife holder 30, the elastic structure 37 can no longer eject the blade body 21 out of the knife holder 30.

Referring again to FIG. 3, the elastic structure 37 includes an actuating piece 24 and an elastic strip 38, wherein the actuating piece 24 is disposed on the other end of the blade body 21. A notch 25 is formed on the elastic piece 24. The elastic strip 38 is extendedly disposed in the knife holder 30 (as shown in FIG. 2). One end of the elastic strip 38 is disposed adjacent the actuating piece 24. When the blade body 21 is rotated into the retaining space 33, the edge of the actuating piece 24 having the largest outer radius will press the elastic strip 38, thereby deforming the elastic strip 38 to reserve some elastic restoration force. Therefore, when the blade body 21 is rotated into the retaining space 33, the user of the foldable knife 20 (as shown in FIG. 2) can use only one hand to hold the knife holder 30 and use the thumb and the index finger to push the actuating rod 23. In this manner, the actuating piece 24 starts rotating and gradually releases the pressing force of the elastic strip 38 until the elastic strip 38 extrudes into the notch 25. Since the elastic strip 38 reserves the elastic restoration force through deformation, the restoration force is exerted to the notch 25 of the actuating piece 24, thereby generating the torque for rotating the blade body 21 out of the retaining space 33. The blade body 21 is then rapidly ejected out of the knife holder 30.

Referring to FIG. 2 and FIG. 3, the surface of the second plate 32 facing the retaining space 33 includes an slightly bent elastic foil 54 formed thereon facing the blade body 21. When the blade body is retained in the retaining space 32, the surface of the blade body 21 press on the elastic foil 54 and deforms the elastic foil 54. When the blade body 21 is rotated out of the retaining space, the elastic foil 54 will be recovered to its slightly bent shape, thus making the end point of the elastic foil 54 contacts the bottom edge of the blade body 21. In this manner, the stability of the blade body 21 disposed on the knife holder 30 is enhanced. This can prevent the foldable knife 20 from accidentally cutting the fingers of the user when the blade body 21 rotates out abruptly. On the contrary, when the elastic foil 54 is deformed from pressing, the bottom edge of the blade body 21 can be released from the contact with the end point of the elastic foil 54. At this time, the blade body 21 can be rotated into the retaining space 33, and presses the elastic foil 54 again.

Referring to FIG. 3, an extension foil 50 is extrusively formed on the foil 43 opposite to one end of the sliding track 44. When the foil 43 rotates in the first plate 31 (as shown in FIG. 2), the extension foil 50 also rotates between the upper cover 35 and the lower cover 36. Further, a penetrating hole 52 is formed on one surface of the lower cover 36 facing the upper cover 35 and being between one end of the lower cover 36 adjacent the pivot 34 and the actuating portion 40, so as to contain therein a locking element 51. A positioning hole 53 is formed on one end of the blade body 21 opposite to the sharp portion 22 and facing one side of the first plate 31. (The preferred position of the positioning hole 53 is between the actuating piece 24 and the actuating rod 23.) In this manner, referring to FIG. 3 and FIG. 7, the positioning hole 53 aligns with the penetrating hole 52 when the blade body 21 is retained in the retaining space, the sliding piece 42 is situated in the sliding groove 41 away from the other end of the foil 43, and the sliding piece 42 is situated in the sliding track 44 away from the other end of the foil 43. The extension foil 50 in the first plate 31 is also aligned to the penetrating hole 52. Now that the locking element 51 contained in the penetrating hole 52 moves towards the retaining space when blocked by the extension foil 50 and enters the positioning hole 53, so as to affix the blade body 21.

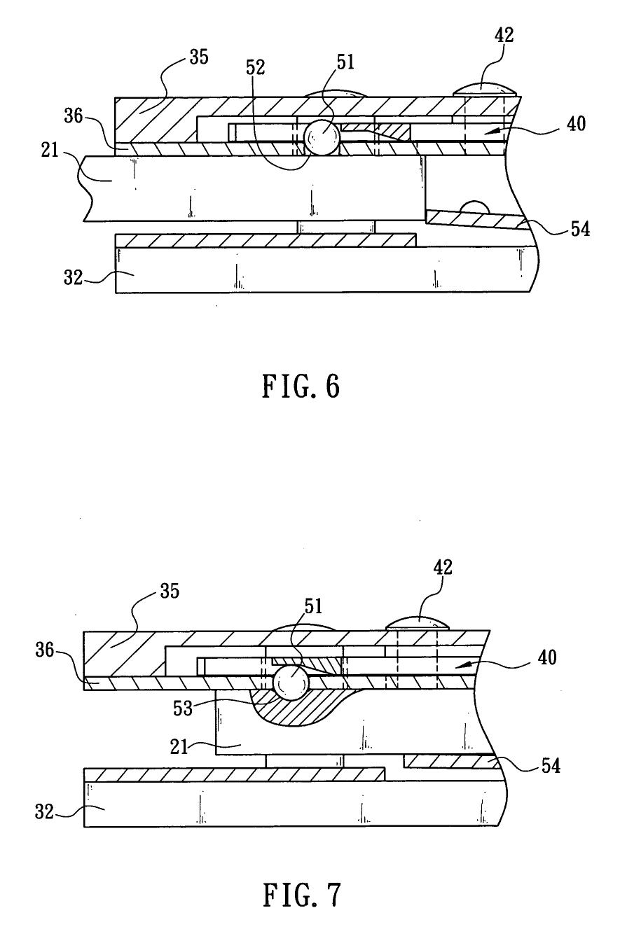

Under this condition, the actuating portion 40 is being operated and the foil 43 starts rotating. The blade body 21 is the driven to rotate out of the retaining space. Referring to FIG. 3 and FIG. 6, the extension foil 50 is also driven to leave its original position. Now, the locking element 51 can move towards the upper cover 35 (or being blocked by the blade body 21 and moves towards the upper cover 35). The blade body 21 can then be rotated out of the retaining space. On the contrary, referring again to FIG. 3 and FIG. 7, when the blade body 21 is retained in the retaining space 33, the extension foil 50 is aligned to the penetrating hole 52 since the actuating portion 40 is not being operated. The locking element 51 is then pushed towards the retaining space 33, whereby the locking element 51 can enter the positioning hole 53 to affix the blade body 21 when the blade body enters the retaining space 33.

While the invention has been described by means of specific embodiments, numerous modifications and variations could be made thereto by those skilled in the art without departing from the scope and spirit of the invention set forth in the following claims.

What is claimed is:

1. A foldable knife, comprising:
a knife holder having a first plate and a second plate stacked on the first plate, wherein a retaining space is formed between the first plate and the second plate;
a blade body, one end of the blade body having a sharp portion formed thereon, the other end of the blade body being pivotally connected to one end of the knife holder, whereby the blade body can be retained in the retaining space or can be rotated out of the retaining space, one surface of the blade body having an actuating rod formed thereon; and
an actuating portion formed on the first plate, whereby the actuating portion can push the adjacent actuating rod to move towards outside of the knife holder, so as to push the blade body out of the retaining space when the blade body is retained in the retaining space.

2. The foldable knife of claim 1, wherein the knife holder comprises an elastic structure, whereby the elastic structure is restricted by the actuating portion when the blade body is retained in the retaining space, so as to keep the blade body being retained in the retaining space, and whereby the blade body ejects out of the knife holder by taking advantage of the elastic force of the elastic structure when the actuating portion pushes the actuating rod to rotate out.

3. The foldable knife of claim 1, wherein the first plate further comprises:
a lower cover; and
an upper cover stacked on the lower cover, the upper cover and the lower cover having the actuating portion contained therebetween, the upper cover comprising a sliding groove formed corresponding to the position of the actuating portion, the sliding groove providing a sliding piece of the actuating portion to extrude the first plate;
a guiding hole formed on one side of the first plate facing the blade body and adjacent the actuating portion, the guiding hole providing the actuating portion to extrude the first plate, thereby pushing the actuating rod.

4. The foldable knife of claim 3, wherein the actuating portion further comprises:
the sliding piece formed between the upper cover and the lower cover, one end of the sliding piece extruding the first plate from the sliding groove;
a foil, which forms an bending angle between two ends thereof, one end of the foil being pivotally connected to the knife holder so as to allow the other end of the foil rotating in the knife holder and extruding from the guiding hole, the other end of the foil further comprising a sliding track for containing the sliding piece, the sliding track crossing the sliding groove;
a recovery spring disposed between the upper cover and the lower cover, one end of the recovery cover being connected to the sliding piece, while the other end of the recovery spring connecting to the first plate.

5. The foldable knife of claim 4, wherein the opposite side surfaces of the blade body adjacent the other end of the blade body and the inner surface of one end of the knife are connected via at least a pivot.

6. The foldable knife of claim 5, wherein one end of the foil is pivotally connected with the pivot for the other end of the foil to rotate about the center of the pivot.

7. The foldable knife of claim 4, wherein the other end of the recovery spring is securely fastened to the upper cover directly facing the sliding groove.

8. The foldable knife of claim 4, wherein the other end of the recovery spring is securely fastened to the lower cover directly facing the sliding groove.

9. The foldable knife of claim 4, wherein the elastic structure comprises:
an actuating piece formed on the other end of the blade body, the actuating piece having a notch formed thereon;
an elastic strip formed in the knife holder, one end of the elastic strip being extended to the adjacent actuating piece.

10. The foldable knife of claim 1, wherein a slightly bent elastic foil is disposed facing the blade body on one surface of the second plate facing the retaining space, whereby the elastic foil that contacts the surface of the blade body is deformed when the blade body is retained in the retaining space, and whereby the elastic foil recovers to its slightly bent shape due to the elastic restoration force when the blade body is rotated out of the retaining space, such that the end point of the elastic foil contacts the bottom edge of the blade body.

11. The foldable knife of claim 4, wherein an extension foil is formed on one end of the foil opposite to the sliding track, the lower cover having a penetrating hole formed thereon for containing a locking element therein, one end of the blade body being the sharp portion while the other end having a positioning hole formed thereon facing one side surface of the first plate, whereby when the blade body is retained in the retaining space, the penetrating hole is aligned to the positioning hole, the extension foil in the first plate is also aligned to the penetrating hole, the locking element contained in the penetrating hole is then blocked by the extension foil to move towards the retaining space and enter into the positioning hole.
